(19) United States
(12) Patent Application Publication
(10) Pub. No.: US 2026/0360779 A1
(43) Pub. Date: Nov. 12, 2026

(54) METHOD FOR OPERATING A FUEL CELL SYSTEM, AND A CONTROL DEVICE

(71) Applicant: Robert Bosch GmbH, Stuttgart (DE)

(72) Inventor: Jan Kappa, Ludwigsburg (DE)

(21) Appl. No.: 19/475,199

(22) PCT Filed: Apr. 16, 2024
(86) PCT No.: PCT/EP2024/060256

§ 371 Date: Oct. 14, 2025

(30) Foreign Application Priority Data
Apr. 19, 2023 (DE) 10 2023 203 562.6

(51) Int. Cl. H01M 8/04089; H01M 8/04119; H01M 8/04746

(52) U.S. Cl. CPC H01M 8/04097; H01M 8/04164; H01M 8/04753

(57) ABSTRACT

The invention relates to a method of operating a fuel cell system, comprising at least one fuel cell stack and an anode circuit for supplying hydrogen to the at least one fuel cell stack, wherein the hydrogen is stocked in a tank, metered into the anode circuit with the aid of a hydrogen metering valve, and recirculated via the anode circuit after exiting the fuel cell stack, and wherein water contained in the recyclate is separated from the gas flow with the aid of a water separator integrated into the anode circuit, collected in a container, and removed from the container by opening a drain valve. According to the invention, the following steps are carried out in order to determine the fill level in the container:
(S1) generating a pressure increase in the anode circuit from a first pressure (p1) to a second pressure (p2),
(S2) measuring the time required for the pressure increase in the anode circle, and
(S3) using the pressure increase time and/or a quantity derived therefrom in order to determine the gas volume and thus the fill level in the container.

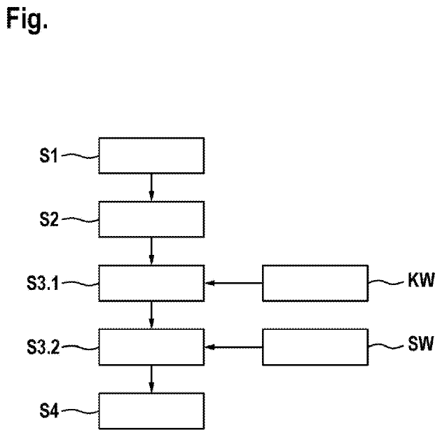

The invention furthermore relates to a control device for carrying out steps of the method.

### BACKGROUND

The invention relates to a method for operating a fuel cell system, in particular a polymer electrolyte membrane (PEM) fuel cell system. Furthermore, the invention relates to a control device configured so as to carry out steps of the method.

With the aid of the fuel cells of a PEM fuel cell system, hydrogen and oxygen can be converted into electrical energy, heat, and water. To increase the electrical output, a large number of fuel cells are stacked into a fuel cell stack. It comprises an anode region supplied with hydrogen via an anode circuit, namely with fresh hydrogen from a tank as well as residual hydrogen contained in the anode gas exiting the fuel cell stack. The anode gas exiting from the fuel cell stack is recirculated via an anode circuit. The oxygen that is further required is provided to the fuel cell stack via an air system, wherein ambient air serves as the oxygen provider.

PEM fuel cell systems typically comprise a water separator in the anode circuit that is intended to separate product water introduced via the membranes of the fuel cells and collect it in a container. The container has a defined volume and is typically designed for a defined maximum amount of water. The maximum amount of water may not be exceeded, because otherwise the water will not remain securely in the container. In particular, the container can overflow or, in mobile uses, spill over during travel. In the worst-case scenario, water that does not remain in the container returns to the stack inlet so that the fuel cell stack can suffer damage. The container is therefore emptied from time to time by opening a drain valve. The drain valve should only be actuated as often and as long as needed so that solely water and no anode gas is drained or blown out via the drain valve. This is because, otherwise, hydrogen is also removed from the anode circuit along with the anode gas so that the hydrogen consumption increases.

Previous concepts for actuating the drain valve therefore rely either on pilot-controlled purge concepts, in which the purge rates are determined on the test bench in advance, or on the use of fill level sensors. Pilot-controlled purge concepts have the disadvantage that they do not take into account unforeseen changes in the operation of the fuel cell system. The use of level sensors in turn is associated with high costs. In mobile uses, fill level sensors are also subjected to vibrations that can affect the measurement result.

### SUMMARY

The present invention addresses the problem of providing a method for operating a fuel cell system that allows for the simplest and most inexpensive determination of the fill level in a container of a water separator. In the method, the use of a fill level sensor is to be omitted, in particular.

To solve this problem, the method according to the disclosure is proposed. Advantageous embodiments of the invention can be found in the dependent claims. In addition, a control device for carrying out the method or individual method steps is specified.

A method is proposed for operating a fuel cell system comprising at least one fuel cell stack and an anode circuit for supplying the at least one fuel cell stack with hydrogen. The hydrogen is stored in a tank, metered into the anode circuit with the aid of a hydrogen dosing valve, and recirculated via the anode circuit after exiting the fuel cell stack. Water contained in the recyclate is separated from the gas flow with the aid of a water separator integrated into the anode circuit, collected in a container, and removed from the container by opening a drain valve. According to the invention, the following steps are carried out in order to determine the fill level in the container:
(S1) generating a pressure increase in the anode circuit from a first pressure pl to a second pressure p2,
(S2) measuring the time required for the pressure increase in the anode circle, and
(S3) using the pressure increase time and/or a quantity derived therefrom in order to determine the gas volume and thus the fill level in the container.

With the fill level, the gas volume in the container, as well as the gas volume in the anode circuit into which the container is integrated, varies. Depending on the fill level, a shorter or longer time is therefore required for the pressure increase from p1 to p2. The pressure increase time and/or a quantity derived therefrom therefore indicates the fill level in the container. The more water there is in the container, the smaller the gas volume and the faster the pressure in the anode circuit increases.

The method requires the presence of a pressure sensor to detect the pressure in the anode circuit. Such a pressure sensor is typically present so that an already existing sensor can be utilized. That is to say, no additional sensor, in particular no fill level sensor, is required.

Advantageously, the pressure in the container, or at least in proximity to the container, is measured. The measurement results then allow for more precise conclusions to be drawn about the pressure increase in the container and thus the volume of gas present in the container. A pressure sensor is therefore preferably used for the measurement, which is arranged in the container, or at least proximate to the container.

The measured pressure increase time and/or a quantity derived therefrom can be used in order to determine the fill level in the container. In particular, this can be a delta time, a filtered pressure increase time, a pressure increase gradient, and/or a filtered pressure increase gradient.

According to a preferred embodiment of the invention, the quantitative relationships between the pressure increase time and the fill level in the container are determined in advance, for example in the context of an application and/or calibration of the fuel cell system. These can then be stored in a control device for evaluating the measured pressure increase time in the operation of the fuel cell system.

Because the time and gradient differences can be small and/or clouded by other effects, it is proposed in a further development of the invention that step S2 is repeated at least once and/or the measured values obtained in step S2 are filtered. Thus, the reliability of the fill level determination increases according to the proposed method.

Furthermore, it is proposed that steps S1 to S3 are repeated periodically. The time intervals should not be selected too large, so that it is detected in a timely manner when the container is full and the drain valve must be opened. In this way, an overflow of the container can be safely prevented.

The pressure in the anode circuit is basically operating point-dependent and is controlled or regulated via the hydrogen dosing valve. To increase the pressure in step S1, the hydrogen dosing valve can be opened further for a short period of time. To simplify the measurement in step S2, it is proposed that at least during the execution of step S2, the amount of hydrogen dosed with the aid of the hydrogen dosing valve is kept constant.

Furthermore, it is preferred that the drain valve and/or a purge valve be kept closed at least during the execution of steps S1 and S2. That is to say, neither water nor anode gas is drained from the anode circuit. Otherwise, the amount of water and/or gas drained must be considered as a correction value.

Because hydrogen is reacted or consumed in the operation of the fuel cell system, the total amount of hydrogen metered with the aid of the hydrogen dosing valve is not available for the pressure increase in the anode circuit. The amount consumed must therefore be deducted from the metered amount. In the further development of the invention, it is therefore proposed that in step S3 the amount of hydrogen consumed during the execution of steps S1 and S2 is considered as a correction value. This is not required when steps S1 and S2 are carried out in an operating phase without load, because then no hydrogen is converted. The amount of hydrogen consumed can be calculated via basic equations with values from current and/or voltage measurements.

Preferably, an operating point-based threshold value for the pressure increase time is determined, which, when fallen below, indicates a fill level that is too high. If the threshold value is stored in a control device for the evaluation of the measured values recorded in step S2, the maximum fill level can be detected by a simple comparison to the threshold value. The threshold value is preferably determined in advance.

Alternatively, or in addition, an operating point-based threshold can be determined for the pressure increase gradient, which, if the threshold is exceeded at a particular operating point, indicates a fill level that is too high. This threshold value is preferably also stored in a control device for the evaluation of the measured values recorded in step S2, so that the evaluation of the measured values is simplified with the aid of the threshold value.

Because the pressure increase in the anode circuit generated in step S1 represents an intrusive procedure that decouples the system pressure from the respective operating point, it is proposed as a further developed measure that steps S1 to S3 be carried out in operating phases of the fuel system in which the system pressure must be increased anyway. Intervention into the system operation is minimal in this case.

In order to solve the problem mentioned at the beginning, a control device is also proposed, which is configured so as to carry out steps of a method according to the invention. The control device can in particular be used in order to evaluate the measured values detected in step S2. For this purpose, quantitative relationships between the pressure increase time and the fill level in the container can be stored in the control device. Threshold values can also be stored which, when exceeded or fallen below, indicate a fill level that is too high. Furthermore, with the aid of the control device, the hydrogen dosing valve can be actuated in order to cause the pressure increase in the anode circuit that is required in step S1. Furthermore, the control device can be used in order to keep the drain valve and/or the purge valve closed. Based on the current operating parameters, with the aid of the control device, at least one correction value can be calculated which, when the drain or purge valve is open, takes into account the amount of water and/or gas discharged thereby and/or deducts the amount of hydrogen that is converted or consumed during the execution of the method. If the evaluation of the measured pressure increase time and/or a quantity derived therefrom indicates that the fill level is too high, the control device can be used in order to open the drain valve and empty the container.

### BRIEF DESCRIPTION OF THE DRAWINGS

The method according to the invention is described in further detail below on the basis of the attached drawing. The drawing shows a flowchart by means of which a preferred method sequence is described.

### DETAILED DESCRIPTION

The method according to the invention, which serves to determine the fill level in a container of a water separator integrated into an anode circuit, comprises a plurality of method steps, which are carried out one after the other, as shown by way of example in the FIGURE.

In a first step S1, the pressure in the anode circuit is increased from a first pressure pl to a second pressure p2. For this purpose, a defined amount of hydrogen is metered into the anode circuit with the aid of a hydrogen metering valve. In a step S2, with the aid of at least one pressure sensor, the pressure in the anode circuit is measured, so that it can be discerned based on the measurement when the pressure p2 is reached. The time required for the pressure increase is also recorded and evaluated in a step S3 with the aid of a control device. The evaluation uses quantitative relationships between the pressure increase time and the fill level in the container, which were determined in advance and stored in the control device.

As shown by way of example in the FIGURE, the evaluation in step S3 can be divided into a plurality of sub-steps. In a sub-step S3.1, for example, an operating point-based evaluation of the measured values detected in step S2 can be performed. Correction values KW can also be included, for example in order to account for the hydrogen conversion in the fuel cells, the valve control, in particular the control of the drain and/or purge valve. If these are opened, the water or gas quantity discharged therefrom is considered by way of a correction value. In a further sub-step S3.2, a comparison of the possibly corrected measured values to at least one threshold value SW can then be made, which indicates a fill level that is too high in the container.

If the evaluation in step S3 shows that the fill level in the container is too high, then, in a step S4, the drain valve is opened and the container is emptied. The actuation of the drain valve can be performed using the control device.

1. A method of operating a fuel cell system, comprising fuel cell stack and an anode circuit for supplying hydrogen to the fuel cell stack, wherein the hydrogen is stocked in a tank, metered into the anode circuit via a hydrogen metering valve, and recirculated via the anode circuit after exiting the fuel cell stack, and wherein water contained in the recyclate is separated from a gas flow via a water separator integrated into the anode circuit, collected in a container, and removed from the container by opening a drain valve,
the method comprising:
(S1) generating a pressure increase in the anode circuit from a first pressure (p1) to a second pressure (p2),
(S2) measuring a time required for the pressure increase in the anode circuit, and
(S3) using the pressure increase time and/or a quantity derived therefrom to determine a gas volume and thus a fill level in the container.

2. The method according to claim 1,
wherein quantitative relationships between the pressure increase time and the fill level in the container are determined in advance.

3. The method according to claim 1,
wherein step (S2) is repeated and/or measured values obtained in step (S2) are filtered.

4. The method according to claim 1,
wherein steps (S1) to (S3) are repeated periodically.

5. The method according to claim 1,
wherein at least during execution of step (S2), an amount of hydrogen metered via a hydrogen dosing valve is kept constant.

6. The method according to claim 1,
wherein at least during execution of steps (S1) and (S2), the drain valve and/or a purge valve is/are kept closed.

7. The method according to claim 1.
wherein in step (S3), an amount of hydrogen consumed during execution of steps (S1) and (S2) is considered as a correction value, wherein the amount of hydrogen consumed is calculated via values from current and/or voltage measurements.

8. The method according to claim 1,
wherein an operating point-based threshold value for the pressure increase time is determined, which, when fallen below, indicates a fill level that is too high.

9. The method according to claim 1, wherein an operating point-based threshold for a pressure increase gradient is determined, which, when exceeded, indicates a fill level that is too high.

10. The method according to claim 1, wherein steps (S1) to (S3) are carried out in operating phases of the fuel system in which the system pressure must be increased.

11. A control device configured to operate a fuel cell system that includes a fuel cell stack and an anode circuit for supplying hydrogen to the fuel cell stack, wherein the hydrogen is stocked in a tank, metered into the anode circuit via a hydrogen metering valve, and recirculated via the anode circuit after exiting the fuel cell stack, and wherein water contained in a recyclate is separated from a gas flow via a water separator integrated into the anode circuit, collected in a container, and removed from the container by opening a drain valve, by:
(S1) controlling a pressure increase in the anode circuit from a first pressure (p1) to a second pressure (p2),
(S2) measuring a time required for the pressure increase in the anode circuit, and
(S3) using the pressure increase time and/or a quantity derived therefrom to determine a gas volume and thus a fill level in the container.
